(19) United States
(12) Patent Application Publication
(10) Pub. No.: US 2025/0181302 A1
(43) Pub. Date: Jun. 5, 2025

(54) DISPLAY SYSTEM AND DISPLAYING METHOD

(71) Applicant: Optoma Corporation, New Taipei City (TW)

(72) Inventor: Jung-Chang Lin, New Taipei City (TW)

(73) Assignee: Optoma Corporation, New Taipei City (TW)

(21) Appl. No.: 18/929,625

(22) Filed: Oct. 29, 2024

(30) Foreign Application Priority Data
Dec. 4, 2023 (TW) 112146991

(51) Int. Cl. G06F 3/14; G06F 3/04842

(52) U.S. Cl. CPC G06F 3/1454; G06F 3/04842

(57) ABSTRACT

A display system and a displaying method are disclosed. The method includes: selecting a first presentation file from at least one presentation file by the first computing device of the first mobile device according to a first user command, obtaining a first slide and first speaker notes corresponding to the first slide from the first presentation file, and transmitting the first slide and the first speaker notes to the display apparatus; forwarding the first speaker notes by the display apparatus to the second computing device of the second mobile device; and displaying the first slide by the first display device of the first mobile device, displaying the first slide by the display apparatus, and displaying the first speaker notes by the second display device of the second mobile device.

### CROSS-REFERENCE TO RELATED APPLICATION

This application claims the priority benefit of Taiwan application serial no. 112146991, filed on Dec. 4, 2023. The entirety of the above-mentioned patent application is hereby incorporated by reference herein and made a part of this specification.

### BACKGROUND

### Technical Field

This disclosure relates to a display system and a displaying method, and in particular to a displaying method that displays slides and note content respectively, and a display system adapted to the displaying method.

### Description of Related Art

When a speaker uses a laptop computer to read or edit a presentation file, the laptop computer displays slides and the speaker notes. The speaker can use the prompts in the speaker notes to deliver the presentation. However, when a laptop computer is communicating with a projector, an interactive flat panel, or an interactive whiteboard, in the case of an interactive flat panel, for example, since a laptop computer performs screen mirroring, neither the interactive flat panel nor the laptop computer can display the speaker notes when the interactive flat panel is showing a slide provided by the laptop computer, so the speaker may not be able to view the speaker notes.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a display system and a displaying method, capable of executing a screen mirroring program on a first mobile device. When a display apparatus displays a slide, a first mobile device can display the slide and a second mobile device can display speaker notes.

In order to achieve one, part, or all of the above purposes or other purposes, a display system according to an embodiment of the disclosure includes a first mobile device, a second mobile device, and a display apparatus. The first mobile device includes a first computing device and a first display device, where the first computing device is electrically connected to the first display device. The second mobile device includes a second computing device and a second display device, where the second computing device is electrically connected to the second display device. The display apparatus is communicatively connected to the first mobile device and the second mobile device through a network. The first computing device is configured to select a first presentation file from at least one presentation file according to a first user command, obtain a first slide and first speaker notes corresponding to the first slide from the first presentation file, and transmit the first slide and the first speaker notes to the display apparatus, where the display apparatus is configured to forward the first speaker notes to the second computing device of the second mobile device, and the first display device of the first mobile device is configured to display the first slide, the display apparatus is configured to display the first slide, and the second display device of the second mobile device is configured to display the first speaker notes.

In an embodiment of the disclosure, the first computing device obtains a second slide and second speaker notes corresponding to the second slide from the first presentation file, where the first computing device is configured to switch the first slide displayed on the display apparatus to the second slide and switch the first speaker notes displayed on the second display device to the second speaker notes according to a second user command.

In an embodiment of the disclosure, the first computing device is configured to determine whether the display apparatus and the first mobile device are in the same network. In response to the display apparatus and the first mobile device being in the same network, the first mobile device is communicatively connected to the display apparatus.

In an embodiment of the disclosure, the display apparatus is configured to determine whether the second mobile device and the display apparatus are in the same network. In response to the second mobile device and the display apparatus being in the same network, the display apparatus is communicatively connected to the second mobile device.

In an embodiment of the disclosure, the display apparatus is configured to receive a second user command from the first computing device, and select the second mobile device from at least one mobile device in the network according to the second user command.

In order to achieve one, part, or all of the above purposes or other purposes, the displaying method according to an embodiment of the disclosure is adapted to a display system. The display system includes a first mobile device, a display apparatus, and a second mobile device. The first mobile device includes a first computing device and a first display device, the second mobile device includes a second computing device and a second display device, and through a network, the first mobile device is communicatively connected to the display apparatus, the second mobile device is communicatively connected to the display apparatus, and the displaying method includes the following. The first computing device of the first mobile device selects a first presentation file from at least one presentation file according to a first user command, obtains a first slide and first speaker notes corresponding to the first slide from the first presentation file, and transmit the first slide and the first speaker notes to the display apparatus. The display apparatus forwards the first speaker notes to the second computing device of the second mobile device. The first display device of the first mobile device displays the first slide, the display apparatus displays the first slide, and the second display device of the second mobile device displays the first speaker notes.

In an embodiment of the disclosure, the method further includes the following. The first computing device obtains a second slide and second speaker notes corresponding to the second slide from the first presentation file. The first computing device switches the first slide displayed on the display apparatus to the second slide and switches the first speaker notes displayed on the second display device to the second speaker notes according to a second user command.

In an embodiment of the disclosure, the method further includes the following. The first computing device determines whether the display apparatus and the first mobile device are in the same network. In response to the display apparatus and the first mobile device being in the same network, the first mobile device is communicatively connected to the display apparatus.

In an embodiment of the disclosure, the method further includes the following. The display apparatus determines whether the second mobile device and the display apparatus are in the same network. In response to the second mobile device and the display apparatus being in the same network, the display apparatus is communicatively connected to the second mobile device.

In an embodiment of the disclosure, the method further includes the following. The display apparatus receives a second user command from the first computing device, and selects the second mobile device from at least one mobile device in the network according to the second user command.

Based on the above, the first mobile device of the disclosure can extract the slide and speaker notes from the presentation file, and can display the speaker notes through the second mobile device for user reference when the display apparatus displays the slide.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 illustrates a schematic diagram of a display system according to an embodiment of the disclosure.

FIG. 2 illustrates a schematic diagram of a first mobile device selecting a second mobile device according to an embodiment of the disclosure.

FIG. 3 is a schematic diagram of a first mobile device selecting a presentation file according to an embodiment of the disclosure.

FIG. 4 and FIG. 5 illustrate schematic diagrams of each display device of a display system displaying a slide and speaker notes according to an embodiment of the disclosure.

FIG. 6 illustrates a flow chart of a displaying method for displaying a slide according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

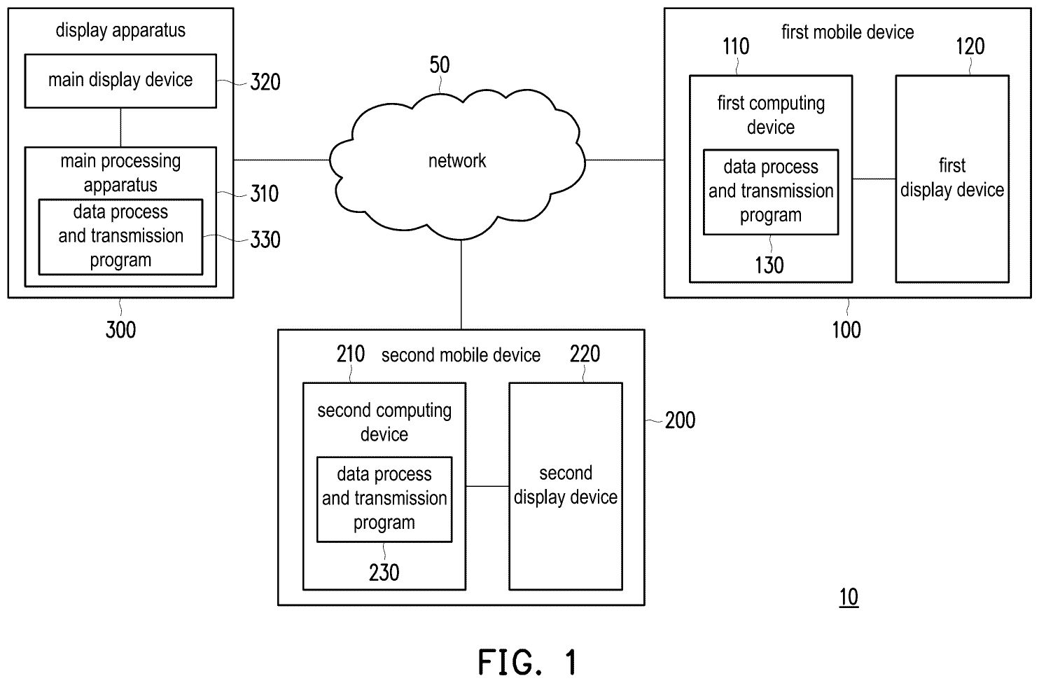

FIG. 1 illustrates a schematic diagram of a display system 10 according to an embodiment of the disclosure. The display system 10 may include a first mobile device 100, a second mobile device 200, and a display apparatus 300. The first mobile device 100 is, for example, a terminal device such as a personal computer, laptop computer, or tablet computer. The second mobile device 200 is, for example, a terminal device such as a smartphone or a personal digital assistant. The display apparatus 300 is, for example, an interactive flat panel, an interactive whiteboard, or a projector. The first mobile device 100, the second mobile device 200, and the display apparatus 300 can communicate with each other through a network 50, where the network 50 is, for example, a local area network or a mobile network.

The first mobile device 100 may include a first computing device 110 and a first display device 120, where the first computing device 110 is electrically connected to the first display device 120. The first computing device 110 is, for example, at least one processor, at least one central processing unit (CPU), a graphics processing unit (GPU), or other programmable general or special purposes microprocessor, digital signal processor (DSP), programmable controller, application specific integrated circuit (ASIC), programmable logic device (PLD), other similar at least one processing chip or at least one circuit, or a combination of these devices. The first display device 120 is, for example, an LED display panel, a liquid crystal display panel, or other types of display panels, which is not limited thereto. The first mobile device 100 also includes a communication device (such as various communication chips, mobile communication chips, Bluetooth chips, or WiFi chips and related multiple circuits), a storage (such as removable random access memory, flash memory, or hard drive), and an input interface device (such as touch screen, keyboard, or mouse), etc. The above hardware is electrically connected to the first computing device 110. In one embodiment, the storage of the first mobile device 100 can store a data process and transmission program 130, the first computing device 110 can store/retrieve the data process and transmission program 130 of the storage, and the first computing device 110 is used to execute the data process and transmission program 130 to transmit a slide of a first presentation file.

The second mobile device 200 may include a second computing device 210 and a second display device 220, where the second computing device 210 is electrically connected to the second display device 220. The hardware of the second mobile device 200 such as the second computing device 210, the second display device 220, a communication device, a storage, and an input interface device are similar to the hardware described in the first mobile device 100, and will not be repeated in the following. The hardware is electrically connected to the second computing device 210. In one embodiment, the storage of the second mobile device 200 can store a data process and transmission program 230, the second computing device 210 can store/retrieve the data process and transmission program 230 of the storage, and the second computing device 210 is used to execute the data process and transmission program 230 to receive speaker notes of the first presentation file.

The display apparatus 300 includes a main processing apparatus 310 and a main display device 320, where the main processing apparatus 310 is electrically connected to the main display device 320. The hardware of the display apparatus 300 such as the main processing apparatus 310, the main display device 320, a communication device, a storage, and an input interface device are similar to the hardware described in the second mobile device 200, and will not be repeated in the following. The hardware is electrically connected to the main processing apparatus 310. In one embodiment, the storage of the display apparatus 300 can store a data process and transmission program 330, and the main processing apparatus 310 can access/retrieve and execute the data process and transmission program 330. The main display device 320 of the display apparatus 300 is, for example, an LED display panel, a liquid crystal display panel, other types of display panels, or an optical engine. The optical engine is used to project images on the screen or wall.

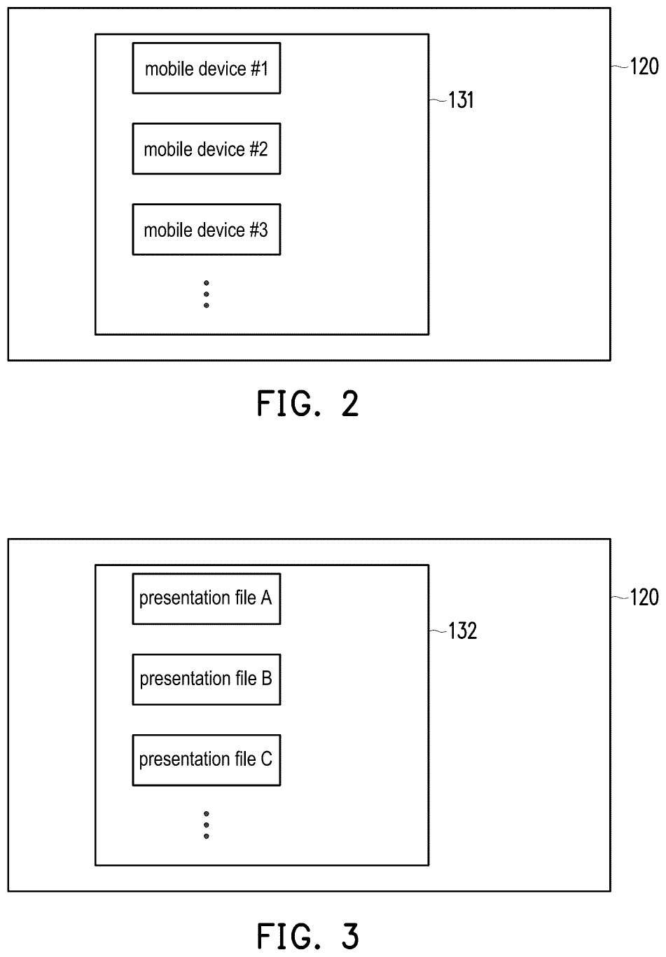

FIG. 2 illustrates a schematic diagram of a first mobile device 100 selecting a second mobile device 200 according to an embodiment of the disclosure. Through the network 50, the communication device of the first mobile device 100 is communicatively connected to the communication device of the display apparatus 300, and the communication device of the second mobile device 200 is communicatively connected to the communication device of the display apparatus 300. There is no communication connection between the first mobile device 100 and the second mobile device 200. In one embodiment, the first computing device 110 executes the data process and transmission program 130, and displays a first graphical user interface 131 through the first display device 120. The first graphical user interface 131 displays a list of a mobile device #1, a mobile device #2, or a mobile device #3 for user to select. If the user wants to select the second mobile device 200 from these mobile devices, the first computing device 110 executes the data process and transmission program 130 for transmitting a user command corresponding to the second mobile device 200 to the display apparatus 300.

To further explain, in one embodiment, the first computing device 110 of the first mobile device 100 executes the data process and transmission program 130, and is communicatively connected to the main processing apparatus 310 of the display apparatus 300 executing the data process and transmission program 330 through the network 50. In one embodiment, the first computing device 110 executes the data process and transmission program 130 to determine whether the display apparatus 300 and the first mobile device 100 are in the same network (i.e., the network 50). If the result of the determination is that the display apparatus 300 and the first mobile device 100 are not in the same network, the data process and transmission program 130 cannot be communicatively connected to the display apparatus 300 through the network 50. If the result of the determination is that the display apparatus 300 and the first mobile device 100 are in the same network, the first computing device 110 executing the data process and transmission program 130 can be communicatively connected to the main processing apparatus 310 executing the data process and transmission program 330 through the network 50. The first computing device 110 can communicate with the main processing apparatus 310 to control the display apparatus 300. For example, the first computing device 110 can control the display apparatus 300 to display a slide.

On the other hand, the main processing apparatus 310 of the display apparatus 300 executes the data process and transmission program 330 to determine whether the mobile device and the display apparatus 300 are in the same network (i.e., the network 50). If at least one mobile device is on the same network as the display apparatus 300, the main processing apparatus 310 of the display apparatus 300 executes the data process and transmission program 330, which provides to the first mobile device 100 a list of names of the at least one mobile device that is in the same network as the display apparatus 300. The second mobile device 200 is selected from the at least one mobile device in the network (e.g., the mobile device #1, #2, or #3 as shown in FIG. 2) according to the user command, and the display apparatus 300 is enabled to be communicatively connected to the second mobile device 200.

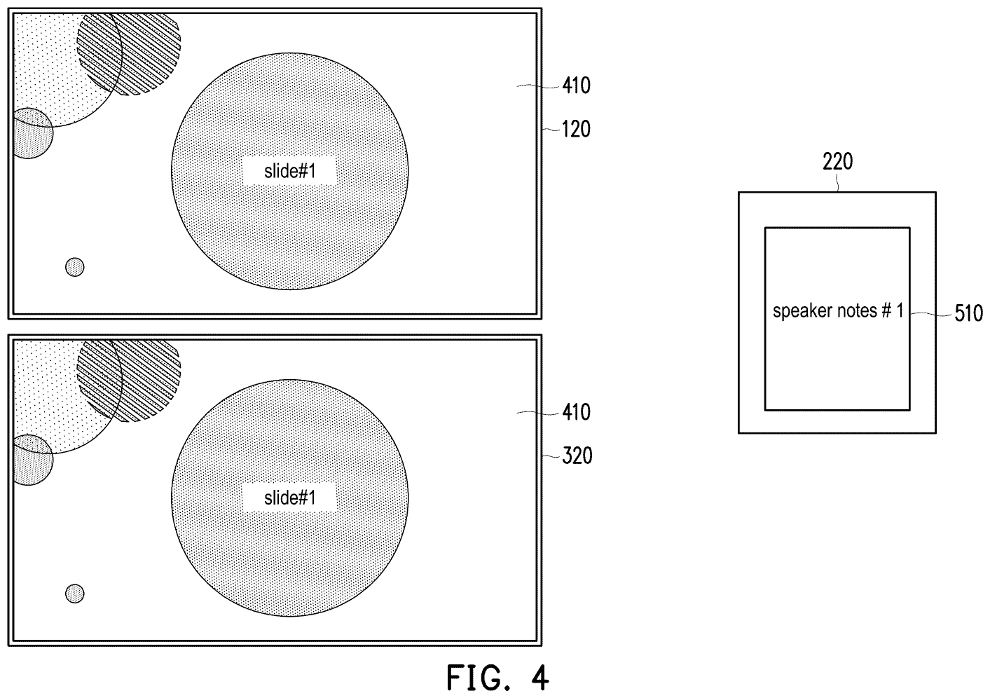

FIG. 3 is a schematic diagram of a first mobile device 100 selecting a presentation file according to an embodiment of the disclosure. Through the network 50, the first computing device 110 of the first mobile device 100 is communicatively connected to the main processing apparatus 310 of the display apparatus 300, and the second computing device 210 of the second mobile device 200 is communicatively connected to the main processing apparatus 310 of the display apparatus 300. The first computing device 110 can read one or more presentation files from the storage or external electronic devices, and can display the one or more presentation files (presentation file A, B, or C as shown in FIG. 3) through a second graphical user interface 132 displayed by the first display device 120 for the user to select. The data process and transmission program 130 can receive a user command and select a first presentation file from the one or more presentation files according to the user command. Next, the first computing device 110 executes the data process and transmission program 130 to further obtain one or more slides and one or more speaker notes corresponding to the one or more slides from the first presentation file. The first graphical user interface 131 and the second graphical user interface 132 are, for example, display windows that can be moved, enlarged, or reduced by the user.

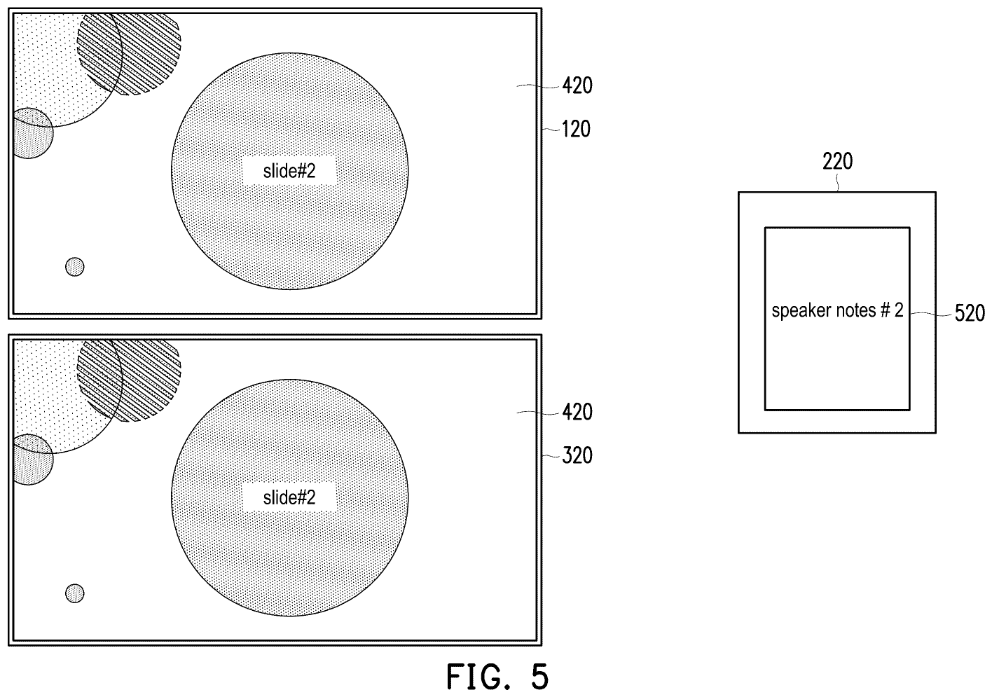

FIG. 4 and FIG. 5 illustrate schematic diagrams of each display device of a display system 10 displaying a slide and speaker notes according to an embodiment of the disclosure. Referring to FIG. 4, if the user wants to display a slide 410, the user can input a user command to the first mobile device 100. The first computing device 110 executes the data process and transmission program 130. The first display device 120 of the first mobile device 100 displays a third graphical user interface (not shown), allowing the user to select whether to let the first computing device 110 execute a screen mirroring program. If the user selects yes, the first computing device 110 of the first mobile device 100 can execute the screen mirroring program according to the user command to transmit the slide 410 and speaker notes 510 of the selected first presentation file to the display apparatus 300. The display apparatus 300 transmits the speaker notes 510 corresponding to the slide 410 to the second mobile device 200. The first display device 120 of the first mobile device 100 displays the slide 410, the main display device 320 of the display apparatus 300 displays the slide 410, and the second display device 220 of the second mobile device 200 displays the speaker notes 510. The so-called screen mirroring program is a program used to synchronize the image displayed on the display device of a mobile device to other mobile devices or display apparatuses, no matter whether it is a photo, a video, a game, etc. to achieve real-time information synchronization on the display device of other mobile devices or display apparatus.

Referring to FIG. 5, if the user wants to switch the displayed slide from the slide 410 to a slide 420, the user can input a user command to the first mobile device 100. The first computing device 110 can switch the slide 410 displayed by the first display device 120 to the slide 420 according to the user command. In addition, the first computing device 110 may transmit the slide 420 and speaker notes 520 corresponding to the slide 420 to the display apparatus 300 according to the user command. The main processing apparatus 310 of the display apparatus 300 switches the slide 410 displayed by the main display device 320 to the slide 420. Furthermore, the main processing apparatus 310 of the display apparatus 300 transmits the speaker notes 520 corresponding to the slide 420 to the second mobile device 200, and the second computing device 210 of the second mobile device 200 switches the speaker notes 510 displayed by the second display device 220 to the speaker notes 520.

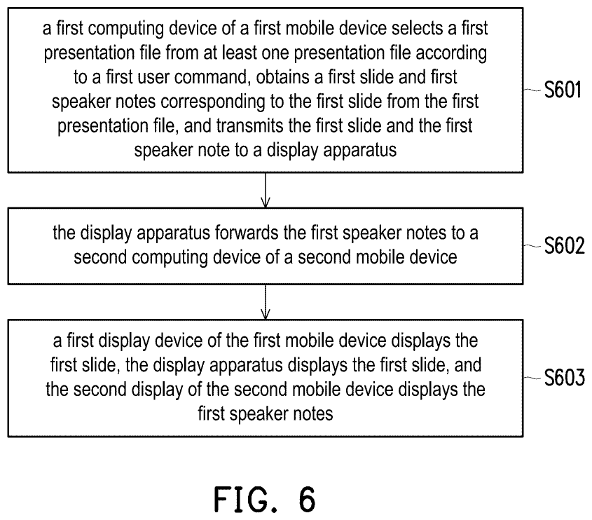

FIG. 6 illustrates a flow chart of a displaying method for displaying a slide according to an embodiment of the disclosure, where the displaying method can be implemented by the display system 10 shown in FIG. 1. In step S601, a first computing device of a first mobile device selects a first presentation file from at least one presentation file according to a first user command, obtains a first slide and first speaker notes corresponding to the first slide from the first presentation file, and transmits the first slide and the first speaker notes to a display apparatus. In step S602, the display apparatus forwards the first speaker notes to a second computing device of a second mobile device. In step S603, a first display device of the first mobile device displays the first slide, the display apparatus displays the first slide, and the second display of the second mobile device displays the first speaker notes.

In addition, before step S601, the displaying method also includes the first computing device of the first mobile device executing a data process and transmission program, and being communicatively connected to the main processing apparatus executing the data process and transmission program through the network. Next, the first computing device of the first mobile device can execute a screen mirroring program according to the user command, followed by step S601 of the method.

In one embodiment, after step S601 and before step S602, through the network 50, the communication device of the first mobile device 100 is communicatively connected to the communication device of the display apparatus 300, and the communication device of the second mobile device 200 is communicatively connected to the communication device of the display apparatus 300. There is no communication connection between the first mobile device 100 and the second mobile device 200. The first computing device 110 executes the data process and transmission program 130, and displays the first graphical user interface 131 through the first display device 120. The first graphical user interface 131 displays a list of a mobile device #1, a mobile device #2, or a mobile device #3 for the user to select. The mobile device #1, the mobile device #2, and the mobile device #3 in the list are communicatively connected to the display apparatus 300.

To sum up, the technical problem to be solved by the disclosure is that when the first mobile device is communicatively connected to the display apparatus and the second mobile device is communicatively connected to the display apparatus, the first mobile device executes the screen mirroring program, so that the first mobile device and the display apparatus display the same screen content. As a result, it is not possible to display additional different screen contents, that is, when the display apparatus displays the slide of the first mobile device, the first mobile device is not able to display additional speaker notes, and the user is not able to view the speaker notes, which affects the smoothness of the speech of the user. This technical problem may be solved by the display system and displaying method of the disclosure.

The display system and displaying method of the embodiment of the disclosure have at least one of the following advantages. The first mobile device of the disclosure can respectively retrieve the slide and the speaker notes from the presentation file, transmit the slide and the speaker notes to the display apparatus without transmitting to the second mobile device. And the display apparatus transmits the speaker notes to the second mobile device. When the first mobile device and the display apparatus display a slide, the second mobile device can display the speaker notes corresponding to the slide. The disclosure can display speaker notes for the user's reference through the second mobile device that the user already owns when making a presentation, providing users with a convenient and low-cost way to display speaker notes.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system, comprising:
a first mobile device, comprising a first computing device and a first display device, wherein the first computing device is electrically connected to the first display device;
a second mobile device, comprising a second computing device and a second display device, wherein the second computing device is electrically connected to the second display device; and
a display apparatus, communicatively connected to the first mobile device and the second mobile device through a network, wherein
the first computing device is configured to select a first presentation file from at least one presentation file according to a first user command, obtain a first slide and first speaker notes corresponding to the first slide from the first presentation file, and transmit the first slide and
the first speaker notes to the display apparatus, wherein the display apparatus is configured to forward the first speaker notes to the second computing device of the second mobile device, and the first display device of the first mobile device is configured to display the first slide, the display apparatus is configured to display the first slide, and the second display device of the second mobile device is configured to display the first speaker notes.

2. The display system according to claim 1, wherein
the first computing device is configured to obtain a second slide and a second speaker notes corresponding to the second slide from the first presentation file, wherein
the first computing device is configured to switch the first slide displayed on the display apparatus to the second slide and switch the first speaker notes displayed on the second display device to the second speaker notes according to a second user command.

3. The display system according to claim 1, wherein
the first computing device is configured to determine whether the display apparatus and the first mobile device are in the same network, wherein
in response to the display apparatus and the first mobile device being in the same network, the first mobile device is communicatively connected to the display apparatus.

4. The display system according to claim 1, wherein the display apparatus is configured to determine whether the second mobile device and the display apparatus are in the same network, wherein in response to the second mobile device and the display apparatus being in the same network, the display apparatus is communicatively connected to the second mobile device.

5. The display system according to claim 4, wherein the display apparatus is configured to receive a second user command from the first computing device, and select the second mobile device from at least one mobile device in the network according to the second user command.

6. A displaying method adapted to a display system, the display system comprising a first mobile device, a display apparatus, and a second mobile device, wherein the first mobile device comprises a first computing device and a first display device, the second mobile device comprises a second computing device and a second display device, and through a network, the first mobile device is communicatively connected to the display apparatus, the second mobile device is communicatively connected to the display apparatus, and the displaying method comprises:
selecting a first presentation file from at least one presentation file by the first computing device of the first mobile device according to a first user command, obtaining a first slide and first speaker notes corresponding to the first slide from the first presentation file, and transmitting the first slide and the first speaker notes to the display apparatus;
forwarding the first speaker notes by the display apparatus to the second computing device of the second mobile device; and
displaying the first slide by the first display device of the first mobile device, displaying the first slide by the display apparatus, and displaying the first speaker notes by the second display device of the second mobile device.

7. The method according to claim 6 further comprising:
obtaining a second slide and second speaker notes corresponding to the second slide by the first computing device from the first presentation file; and
switching the first slide displayed on the display apparatus to the second slide and switching the first speaker notes displayed on the second display device to the second speaker notes by the first computing device according to a second user command.

8. The method according to claim 6 further comprising:
determining whether the display apparatus and the first mobile device are in the same network by the first computing device; and
in response to the display apparatus and the first mobile device being in the same network, the first mobile device is communicatively connected to the display apparatus.

9. The method according to claim 6 further comprising:
determining whether the second mobile device and the display apparatus are in the same network by the display apparatus; and
in response to the second mobile device and the display apparatus being in the same network, the display apparatus is communicatively connected to the second mobile device.

10. The method according to claim 9 further comprising:
receiving a second user command by the display apparatus from the first computing device, and selecting the second mobile device from at least one mobile device in the network according to the second user command.
